(19) United States
(12) Patent Application Publication
(10) Pub. No.: US 2005/0039364 A1
(43) Pub. Date: Feb. 24, 2005

(54) Adjacent road and advertisement signs

(76) Inventors: Drew Vandewart, East Hills, NY (US); David Finkel, New York, NY (US)

Correspondence Address: Eric A. Lerner;Ostrager Chong Flaherty & Broitman PC, Suite 825, 250 Park Avenue, New York, NY, 10117-0899, US

(21) Appl. No.: 10/914,512

(22) Filed: Aug. 9, 2004

Related U.S. Application Data
(60) Provisional application No. 60/492,948, filed on Aug. 7, 2003.

(51) Int. Cl. G09F 15/00

(52) U.S. Cl. 40/612; 40/607.01

(57) ABSTRACT

The invention provides a method and apparatus for supplying advertising space under, above or next-to adjacent to a road sign to allow businesses to advertise and allow drivers to see nearby businesses without taking their eyes off the road. The method would increase the safety of the motorists, while offering increased visibility for businesses and additional revenue to the municipalities where the signs are located in the form of rent for the advertising space.

### RELATED APPLICATION

This application claims the benefit of U.S. Provisional Application Ser. No. 60/492,948, filed Aug. 7, 2003, in accordance with 37 CFR 1.7(b).

### FIELD OF THE INVENTION

This invention generally relates to a method and apparatus for advertising on a roadway without unduly distracting a motorist driving on the roadway. Specifically, the invention relates to an advertisement sign located in close proximity to or adjacent to a municipal sign, such as a road sign. The invention allows a motorist to see the advertising simultaneously with the road sign without substantially taking their attention off the roadway.

### BACKGROUND OF THE INVENTION

As is the nature of a motor vehicle, a typical driver will often find themselves, by choice or by circumstance, driving down unfamiliar streets in an unfamiliar location trying to find a specific type of business establishment or attraction; for example, a specific store, restaurant, bank, pharmacy or tourist attraction. Of course, when a typical driver is driving around unfamiliar streets, it follows that the driver is similarly unfamiliar with the types and locations of the local business establishments. This creates a frustrating and perhaps unsafe condition for the driver and the surrounding traffic.

In order to locate the business establishment of choice, the driver will often have to resort to unsafe driving techniques. Particularly in a city environment, this means that the driver will have to take their eyes off the road to look at the nearby businesses. Similarly, the driver may be forced to consult hand written directions or other navigational material. The more confusing the environment, the longer the driver will have to divert their attention from the road. Obviously, this has the potential to create unnecessary accidents. Ideally, then, a driver can determine the location of the local businesses or attractions without substantially diverting their attention from the road.

There is also a constant need for municipalities to raise budgetary funds. This is frequently achieved by selling advertising on municipal owned property, for example, on mass transit vehicles such as buses or trains. It follows that if a municipality wants to increase its income, one method of doing so would be to create new streams of revenue by finding new locations in which to sell advertising space. Further, business establishments, who desire to beneficially raise their businesses profile and divert pedestrian and vehicular traffic into their stores, would be interested in purchasing the new advertising space. Similarly, the municipalities themselves could use new advertising space. For example, the city may wish to call attention to the locations of municipal buildings, tourist attractions or community events that are in close proximity.

Therefore, there remains a need for a way for drivers to safely locate local establishments while ideally further creating revenue for the host municipality and raising awareness and increasing consumer traffic for the businesses themselves.

### SUMMARY OF THE INVENTION

The present invention seeks to overcome these problems by providing an apparatus and method by which advertising space is provided adjacent municipal street signs, that is, closely under, above, or next-to a municipal sign. This is achieved through a combination road and advertisement sign, comprising an advertisement sign placed adjacent to a road sign, wherein the combination advertisement and road sign is viewable in the ordinary course of driving by drivers that are driving in at least one direction, such that the advertisement sign identifies an attraction, business establishment or municipal building that is located in close proximity to the combination sign.

The invention further provides a method for advertising comprising the steps of placing an advertisement sign adjacent to a road sign, wherein the road sign is viewable in the ordinary course of driving by drivers that are driving in at least one direction, such that the advertisement sign identifies an attraction, business establishment or municipal building that is located in close proximity to the sign, wherein a municipality rents an advertising space to obtain a revenue, wherein the advertising space corresponds to a space occupied by the advertisement sign placed adjacent to the road sign, and further splitting the revenue amongst the municipality, an agency, and/or a licensor.

### BRIEF DESCRIPTION OF THE FIGURES/DRAWINGS

FIG. 1 is a front view of an advertisement sign adjacent to a road sign.

FIG. 2 is a front view of a multiplicity of advertisement signs in close proximity to a road sign.

FIG. 3 is a perspective view of two combinations of road and advertisement signs on a single common support.

FIG. 4 is a perspective view of an illuminated advertisement sign.

FIG. 5 is a chart depicting one method to share the responsibilities created from renting out the advertising space.

### DETAILED DESCRIPTION

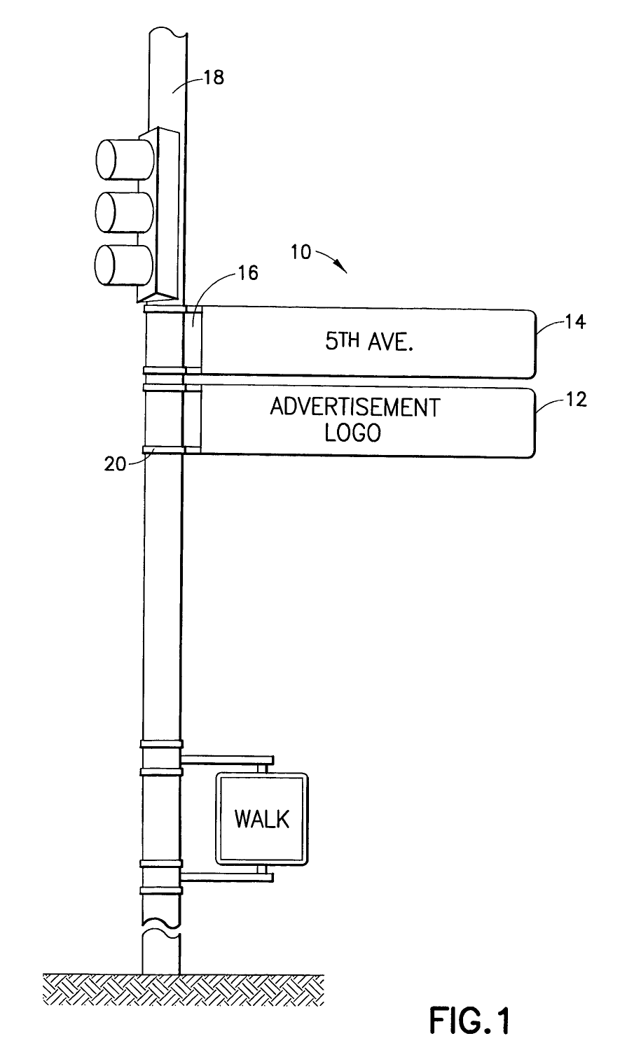

A combination street and advertisement sign 10 in accordance with one embodiment of the invention is shown in FIG. 1. Advertisement sign 12 is a typical commercial sign that can be of any size, shape or color desired by an advertiser that also conforms to a local municipality's regulations. Sign 12 displays the name of a business establishment such as a bank, clothing retailer, pharmacy or any other type of establishment that may exist. Alternatively, sign 12 can depict a promotional slogan or message, such as one that points out a local sale. In other embodiments, the municipality can use the sign itself by displaying the name of a local municipal building, tourist attraction, or other location of interest. Basically, the sign can say anything that is not typically associated with a road sign.

The advertisement sign 12 may depict advertising logos on either side of sign 12. Thus, in one embodiment, sign 12 is visible by viewers in opposite directions. In another embodiment, an advertisement logo on one side of the advertisement sign is different than an advertisement logo on the opposite side of the advertisement sign. Thus, the advertisement can be changed in accordance with the location of the business establishments in either direction.

FIG. 1 further depicts road sign 14 as a street sign that states the name of a cross street. In other embodiments, the road sign can be any type of municipal sign, such as a parking sign, a direction sign, a warning sign, or other signage used to provide information to motorists while keeping their attention on the roadway. Sign 14 can similarly be of any size, shape or color typical for a road sign. Further, the material of the advertisement and road signs can be of any material known in the art that are used for signs, constrained only by the physical location of the signs and the relevant codes in place in the municipality. While FIG. I shows signs 12 and 14 to be of similar dimensions and material, it is not necessary for sign 12 and sign 14 to be of the same general design, shape, material or size.

The advertising space of sign 12 is placed closely under, above, or next-to road sign 14. Signs 12 and 14 are adjacent to each other such that a driver that is driving in at least one direction can read both signs together quickly and easily. This allows drivers to locate nearby businesses without taking their eyes off the road any more than they would under normal driving conditions, creating safer road conditions.

In one embodiment, advertisement sign 12 is fixed adjacent to road sign 14 by an attaching device. As shown in FIG. 1, both signs may be held in place by holding supports 16 and fasteners 20 that attach to a common support 18, such as a lamppost. There are multiple fastening devices known in the art that can attach the advertisement and road signs to a common support. In general, the type of attaching device generally varies with the type of common support. Thus, a common support other than a lamppost would likely require the attaching device known in the art that corresponds to that particular common support.

The depicted holder support 16 in FIG. 1 holds sign 14 adjacent above sign 12. In other embodiments, however, sign 12 could be above, or next-to, sign 14. Further, while the signs are adjacent, there is a slight separation between the advertisement sign and the road sign. Alternatively, signs 12 and 14 may be immediately adjacent, such that the borders of the signs touch each other at at least one point. Regardless of whether they touch or not, the signs must be in close enough proximity such that a motorist driving in at least one direction can read both signs at essentially the same time.

Alternatively, the advertisement sign may be attached directly to the road sign. In one such embodiment, one of the signs, for example, road sign 14, may have small hooks hanging down from the bottom side of the sign, with the other sign, advertisement 12, may have small corresponding holes that can accept the hooks. In this instance, the lower sign would not need its own holder support 16 and could be quickly changed, increasing the ease of use. Further, the road sign and the advertising sign could be part of the same structure. For example, the combination sign could be a solid piece of square material, with the top half of the square painted or imprinted as a road sign, and the bottom half of the square painted or imprinted as an advertisement.

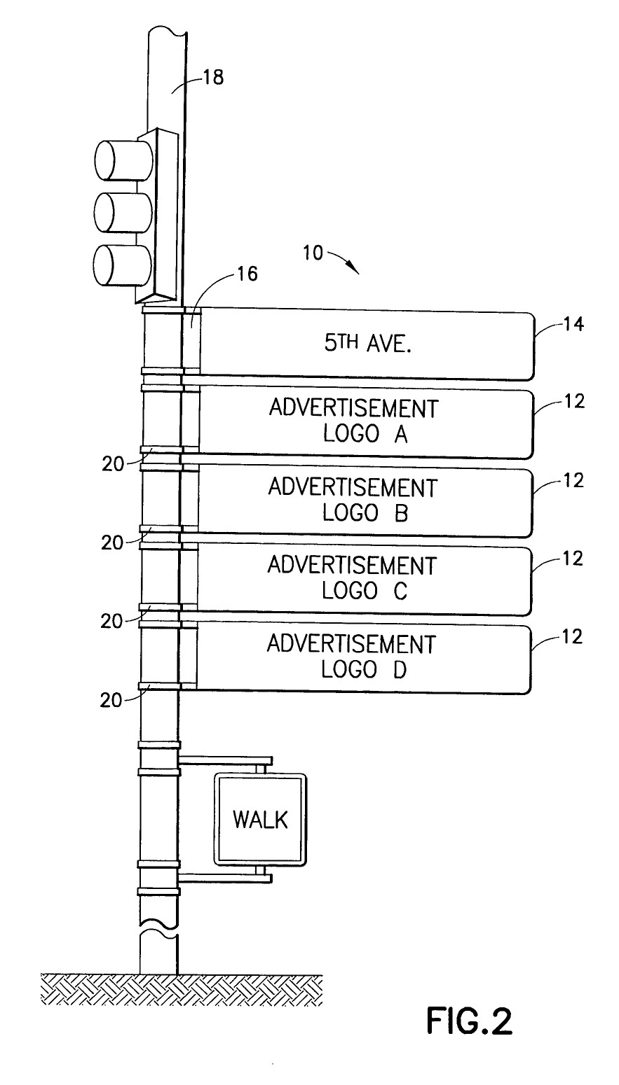

As shown in FIG. 2, the invention provides for a multiplicity of advertisement signs 12 to be held in close proximity to the road sign 14. The signs are all adjacent to one another, such that they are quickly readable by a driver. Each of the signs may be located closely under, above, or next-to municipal street signs. This allows drivers to locate any number of nearby businesses without taking their eyes off the road, thereby creating safer road conditions and increasing the likelihood of finding a desired business establishment that is in close proximity to the signs. This embodiment creates further revenue streams for the municipality. Additionally, the highly visible nature of the invention could also be used by pedestrian traffic, who could view a list of establishments located on a block without actually having to walk down the block, and thereby decide whether to walk down the block, much as one uses signs hanging above a supermarket aisle.

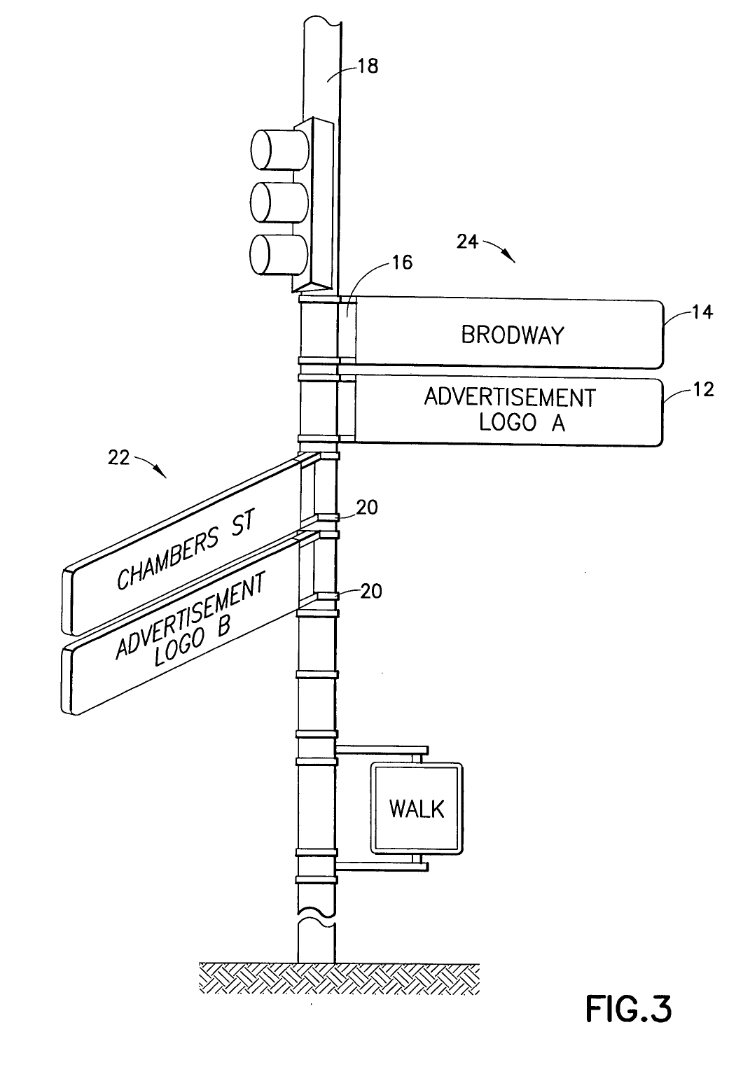

As shown in FIG. 3, multiple combinations of road and advertisement signs may attach to the same common support. As depicted, combination 22 and combination 24 each attach to common support 18. Further, each of the combinations are facing different directions, and thus one combination is viewable by drivers driving in, for example, an east-west direction, while the other combination is viewable by drivers in a north-south direction. Thus, the increased signage will create more revenue streams for the municipality and greater guidance for the viewers, while not significantly increasing clutter.

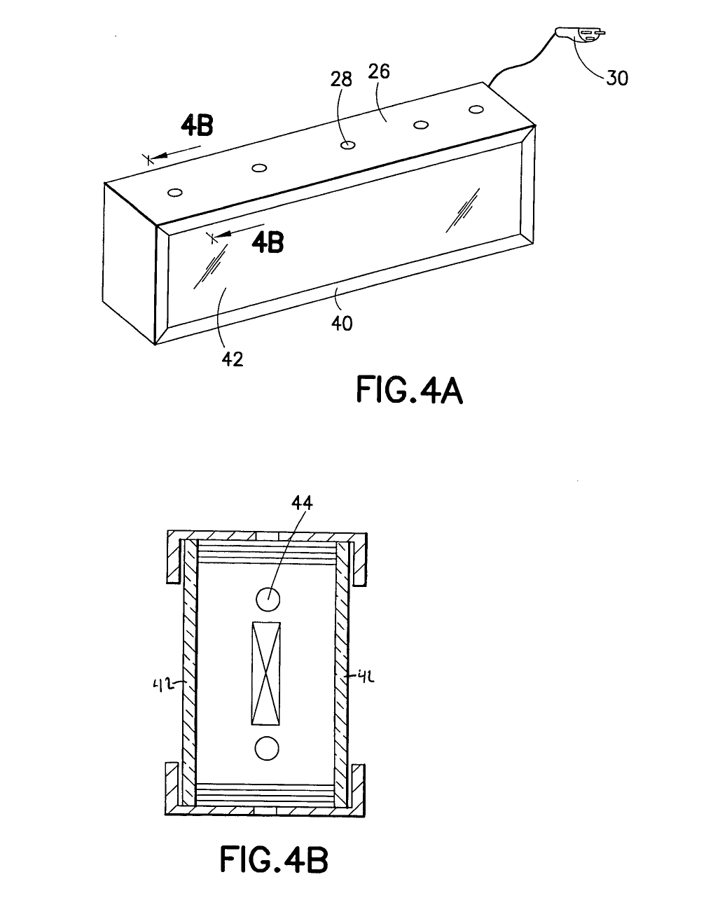

In other embodiments, either one or both of the signs may be illuminated. As shown in FIG. 4A, illumination may be achieved through use of a framed box 26 containing a light fixture. The box is preferably aluminum, although it may be any material commonly used in the art, such as plywood. The dimensions and shape of the box can vary widely within the spirit of the invention. As depicted, the box has a 36 inch length, a 12 inch height, and a 10 inch depth. Other dimensions and embodiments, such as angled side walls or other shapes, may also be used. The box may further include vent holes 28 and a power cord 30 with a grounded plug. The illuminated signs are preferably used when a power source is readily available. One such occurrence is in locations where an illuminated road sign already exists. In this circumstance, the illuminated advertisement sign will draw power from the same source as the existing sign. Alternatively, other methods of illumination may be used. For example, the signs may be of a reflective material, thereby increasing visibility of the signs.

The box further contains a translucent acrylic panel 42 held within the frame, wherein a portion of the panel spells out the desired advertising logo or road sign. The sign may be inwardly recessed from the front of box 26 along recess 40. Recess 40 preferably has mitre corners 46 to hold panel 42 in place.

As shown in FIG. 4B, bulbs 44 are placed inside box 42 and are lit with the power derived from power cord 30. The bulbs are preferably fluorescent bulbs of essentially the same length as the box itself, such that the bulbs extend the length of the box. Once lit, the bulbs will light up the acrylic panel and display the sign depicted on panel 42 in an illuminated manner. As further seen in the cross section, the framed box may contain two acrylic panels 42 on either side of the bulbs. Thus, two advertisement signs can be illuminated in two directions. It follows that both advertisement signs may be slightly recessed inward along a recess with mitre corners.

The method of the invention provides advertising space that is closely under, above, or next-to to a road sign. The method allows the municipality that owns the road signs to rent the advertising space, thereby increasing revenues from a previously untapped revenue source. The municipality may choose a variety of pricing plans concerning the rent, for example, by using pricing zones, wherein certain advertising locations are rented at a higher price rate. For example, the more populated an intersection, the more valuable the advertising space that exists adjacent to a road sign in that intersection. As a result, the municipality may wish to charge a greater rent for that advertising space. The number of different pricing zones is limited only to the amount of advertising space rented. Each advertising space may have its own price, or each space may have the same price, or any combination thereof.

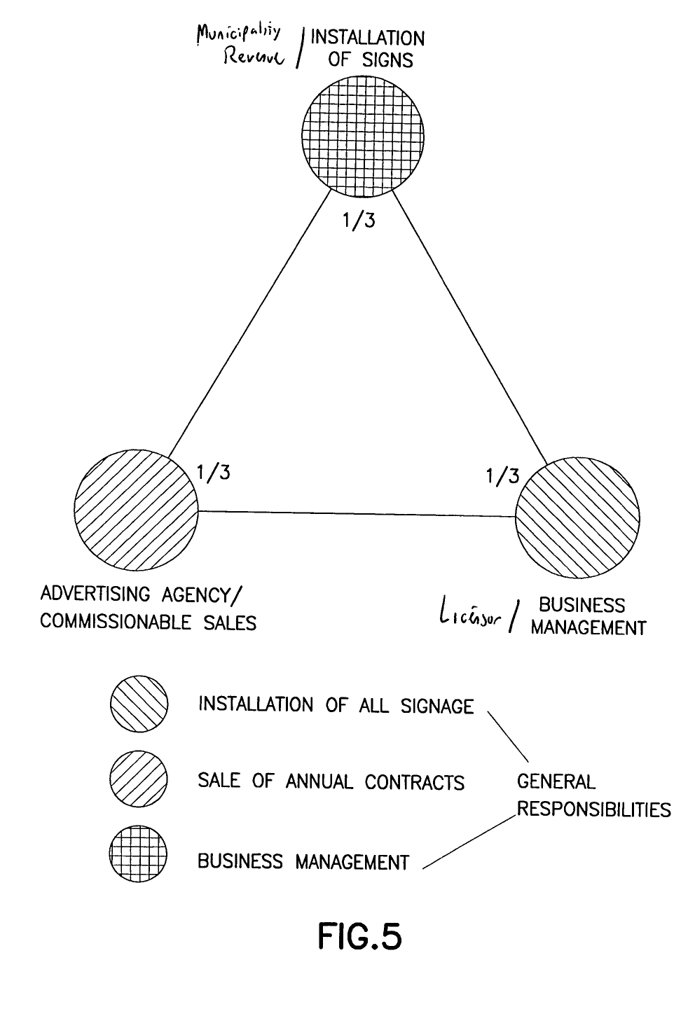

The revenue derived from the selling of the advertising space can be split in any way agreed upon. For example, the revenue may be split equally amongst the municipality, an advertising agency, and/or a licensor. The general responsibilities may be split as well, as depicted in FIG. 5. The expenses of the method, for example, the installation of the signage, the sale of the contracts, and the business management, could all be shared among the parties, as shown in FIG. 5.

The advertisers that purchase the space are ideally business establishments that exist on the particular block or in very close proximity. Thus, a driver can use the signs to locate needed or wanted advertisers in the immediate area without taking their eyes off of the road for an unacceptable length of time. Consequently, the advertisers that rent the advertising space can increase their commercial business. The signs may also serve to increase awareness for the advertisers, thereby reinforcing even local resident's concepts as to where particular establishments are located. In other embodiments, the municipalities themselves can use the advertising space to draw attention to local municipal buildings or tourist attractions, such as courthouses or museums. This would create indirect revenue streams by raising awareness for municipal property.

Although the invention has been described with reference to preferred embodiments, it will be appreciated by one of ordinary skill in the art that numerous modifications are possible in light of the above disclosure. For example, the method may be used in locations outside of a typical city block. All such variations and modifications are intended to be within the scope and spirit of the invention as defined in the claims appended hereto.

1. A method for advertising comprising the steps of:
placing an advertisement sign adjacent to a road sign, forming a combination sign, wherein both the road sign and the advertisement sign are viewable in the ordinary course of driving by drivers that are driving in at least one direction, such that the advertisement sign identifies an attraction, business establishment or municipal building that is located in close proximity to the combination sign.

2. The method for advertising according to claim 1, further comprising the step of placing at least one additional advertisement sign in close proximity to the road sign such that the at least one additional advertisement sign is viewable in the ordinary course of driving by drivers driving in at least one direction.

3. The method for advertising according to claim 1, further comprising the step of having a municipality sell an advertising space to obtain a revenue, wherein the advertising space corresponds to space occupied by the advertisement sign.

4. The method for advertising according to claim 1, wherein a second advertisement sign is placed adjacent to a second road sign, wherein the second road sign and second advertisement sign are viewable by drivers driving in at least a second direction, wherein the second advertisement sign and the second road sign share a common support with the combination sign.

5. The method for advertising according to claim 3, further comprising the step of splitting the revenue amongst the municipality, an agency, and a licensor.

6. The method for advertising according to claim 1, further comprising the step of having a gap between the road sign and the advertisement sign.

7. The method for advertising according to claim 1, further comprising the step of having the road sign physically border the advertisement sign at at least one point.

8. The method for advertising according to claim 1, further comprising the step of illuminating the advertisement sign.

9. The method for advertising according to claim 8, wherein the advertisement sign is written on a translucent acrylic panel and held within a framed box, and wherein a light fixture is contained within the framed box, such that the translucent acrylic panel is illuminated by the light fixture.

10. A combination road and advertisement sign, comprising an advertisement sign placed adjacent to a road sign, wherein both the road sign and advertisement sign are viewable in the ordinary course of driving by drivers that are driving in at least one direction, such that the advertisement sign identifies an attraction, business establishment or municipal building that is located in close proximity.

11. The combination road and advertisement sign according to claim 10, wherein a multiplicity of advertisement signs are placed in close proximity to the road sign such that the multiplicity of advertisement signs are viewable in the ordinary course of driving by drivers driving in at least one direction.

12. The combination road and advertisement sign according to claim 10, wherein a second advertisement sign is placed adjacent to a second road sign, wherein the second road sign and second advertisement sign are viewable by drivers driving in at least a second direction, wherein the second advertisement sign and the second road sign share a common support with the combination road and advertisement sign.

13. The combination road and advertisement sign according to claim 10, wherein there is a gap between the advertisement sign and the road sign.

14. The combination road and advertisement sign according to claim 10, wherein the advertisement sign and the road sign border each other at at least one point.

15. The combination road and advertisement sign according to claim 10, wherein the advertisement sign is illuminated

16. The combination road and advertisement sign according to claim 15, wherein the advertisement sign is written on a translucent acrylic panel and held within a framed box, and wherein a light fixture is contained within the framed box, such that the translucent acrylic panel is illuminated by the light fixture.

17. The combination road and advertisement sign according to claim 10, wherein the road sign has a series of hooks, and the advertisement has a series of holes that are receptive to the hooks, such that the advertisement sign affixes to the road sign when the holes accept the hooks.

18. The combination road and advertisement sign according to claim 10, wherein the road sign is above the advertisement sign.

19. The combination road and advertisement sign according to claim 10, wherein the advertisement sign is above the road sign.

20. A method for advertising comprising the steps of:
placing an advertisement sign adjacent to a road sign, forming a combination sign, wherein both the road sign and the advertisement sign are viewable in the ordinary course of driving by drivers that are driving in at least one direction, such that the advertisement sign identifies an attraction, business establishment or municipal building that is located in close proximity to the combination sign,
having a municipality sell an advertising space to obtain a revenue, wherein the advertising space corresponds to space occupied by the advertisement sign placed adjacent to the road sign, and
splitting the revenue amongst the municipality, an agency, and a licensor.
